(19) United States
(12) Patent Application Publication
(10) Pub. No.: US 2004/0264952 A1
(43) Pub. Date: Dec. 30, 2004

(54) Digital camera

(76) Inventors: Hideshi Oeda, Suita-shi (JP); Yoshinori Hama, Soraku-gun (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/489,857

(22) PCT Filed: Sep. 24, 2002
(86) PCT No.: PCT/JP02/09782

(30) Foreign Application Priority Data
Sep. 25, 2001 (JP) 2001-291652

(51) Int. Cl. G03B 17/18

(52) U.S. Cl. 396/287

(57) ABSTRACT

The present invention provides a digital camera which is adapted to set one mode from among a plurality of modes including a still picture mode, continuous shooting mode, and motion picture mode. With the digital camera, a manipulation for setting a mode displays an icon Ib indicating the mode to be set on an image monitor 9 over a constant period of time before the transition to the mode to be set. Accordingly the mode can be selected/set on a screen of the image monitor 9, and the user is free from uneasiness in setting the mode.

### TECHNICAL FIELD

The present invention relates to digital cameras which are adapted to set one mode from among a plurality of modes including a still picture mode for shooting or reproducing a still picture in response to the user's manipulation for setting a mode.

### BACKGROUND TECHNOLOGY

In digital cameras it is possible to select and set a plurality of modes including a still picture mode for shooting or reproducing a still picture, motion picture mode for shooting or reproducing a motion picture, continuous shooting mode for shooting or reproducing a continuous shooting image, optional mode for setting date and time. The modes have been heretofore selected by switching a selection button arranged in the vicinity of a shutter button.

The digital cameras, however, are provided with a number of buttons, other than the described selection button and shutter button, including a main switch to be manipulated for turning on/off power supply and switching between shooting and playback, a mode button to be manipulated for displaying a setting screen for changing over each set value like shooting resolution, etc., an arrow button to be manipulated for selecting one icon from among a plurality of icons displayed on a menu screen, and a setting button to be manipulated for setting a set value as to the selected icon, etc., entailing the problem of cumbersome manipulation of the buttons.

A method is studied that without the selection button, setting mode is performed by manipulating a cursor on a screen such that one mode is selected and set from a plurality of modes displayed on a monitor screen. This method makes it possible to select a mode by the manipulation of the arrow button, and also makes it possible to set a mode by the manipulation of the setting button, thereby reducing the number of manipulation buttons, whereby the button manipulation is performed with ease.

However, this method omits a selection button for confirming visually a mode selected with reference to a selected position. This makes it impossible for the user to confirm visually which mode is set in selecting a mode from among a plurality of modes shown on the screen and manipulating the setting button. This gives rise to the problem that the user has an uneasy sense about the manipulation.

An object of the present invention is to provide a digital camera which is adapted to select/set a mode not by a mode button but by manipulation of a cursor on a screen, and which is free from the user's uneasiness in setting the mode.

### DISCLOSURE OF THE INVENTION

The present invention provides a digital camera which is adapted to set one mode from among a plurality of modes including a still picture mode for shooting or reproducing a still picture in response to a manipulation for setting a mode, the digital camera for displaying an image indicating a mode to be set on a monitor over a constant period of time before transition to the mode to be set when the manipulation for setting the mode is performed.

With the digital camera of the present invention, setting mode is performed by manipulating a cursor on a screen such that one mode is selected and set from a plurality of modes shown on a monitor screen. Simultaneously with the user's selecting/setting a mode on a monitor screen, an image indicating a mode to be set is shown on the monitor screen over a constant period of time, and the set mode thereafter follows.

Stated specifically, the digital camera of the present invention comprises image storage for storing images which indicate the plurality of modes, respectively, recognizer for recognizing the mode to be set in response to the manipulation for setting the mode, measurer for measuring the constant period of time in response to the manipulation for setting the mode, and displayer for displaying on a monitor the image stored in said image storage over the constant period of time. According to the specific construction, the user's manipulation for setting a mode starts to measure the constant period of time, and at the same time, a mode to be set is recognized to display an image indicating the mode on the monitor screen. Thereafter the constant period of time elapses, to discontinue displaying the image, followed by the mode which has been set.

Further stated specifically, the image indicating the mode is an icon indicating characteristics of the mode. Accordingly the user can recognize, with ease, the mode which has been set.

Stated more specifically, the image indicating the mode is character strings indicating a call name of the mode. Accordingly the user can recognize, with ease, the mode which has been set.

As described above, the digital camera of the present invention enables the user to confirm visually which mode is set right after the manipulation for selecting/setting a mode, so that the user will feel no uneasiness in manipulation.

### DETAILED DESCRIPTION OF THE DRAWINGS

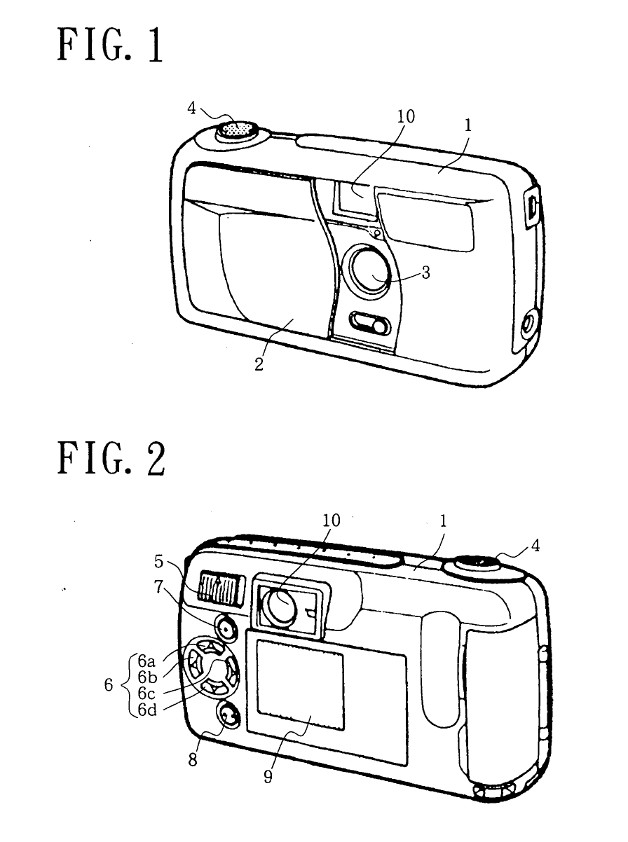

FIG. 1 is a perspective view of a digital camera of the present invention from the front side thereof;

FIG. 2 is a perspective view of the digital camera from the rear side thereof;

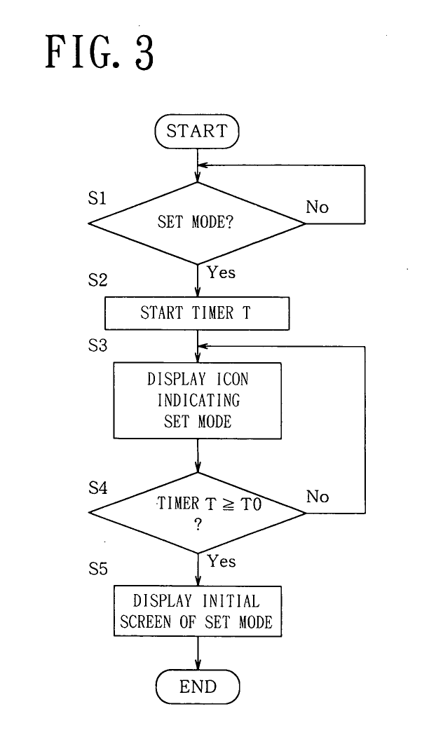

FIG. 3 is a flowchart showing a procedure for screen display when the digital camera sets a mode;

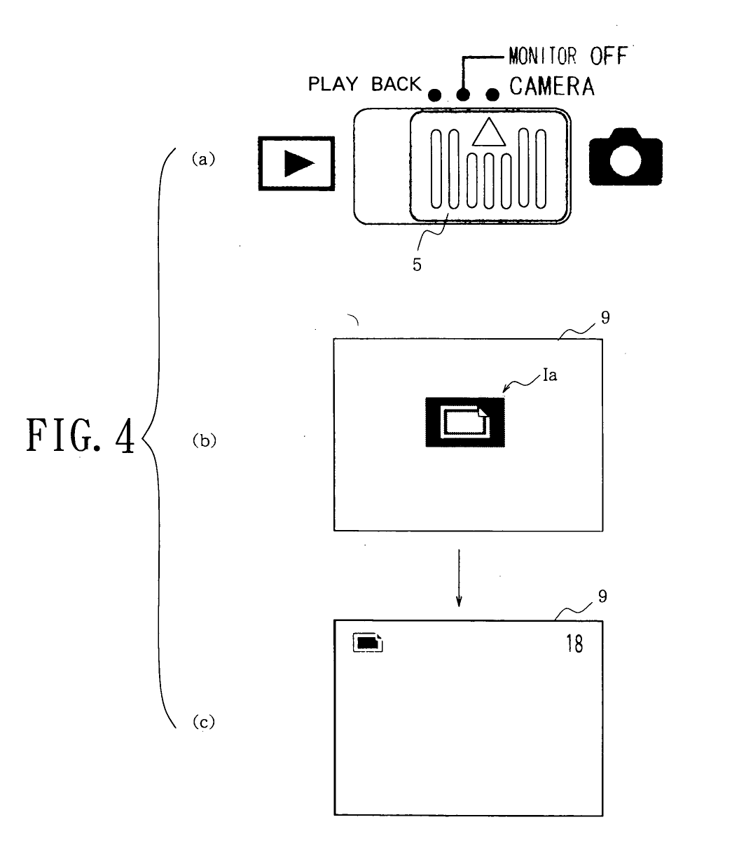

FIG. 4 is a diagram showing an example of screen display when a still picture mode is to be set;

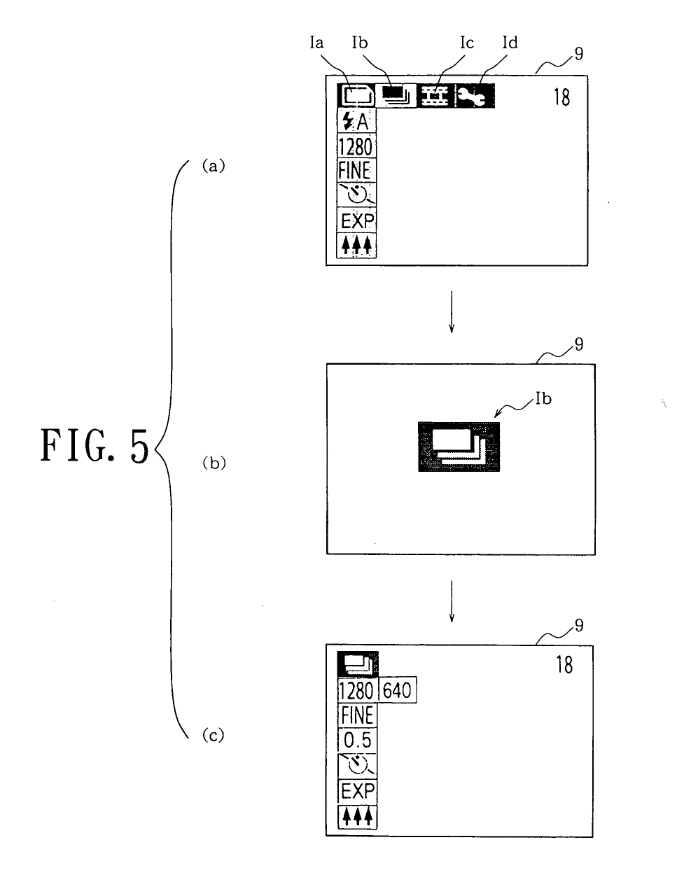

FIG. 5 is a diagram showing an example of screen display when a continuous shooting mode is to be set;

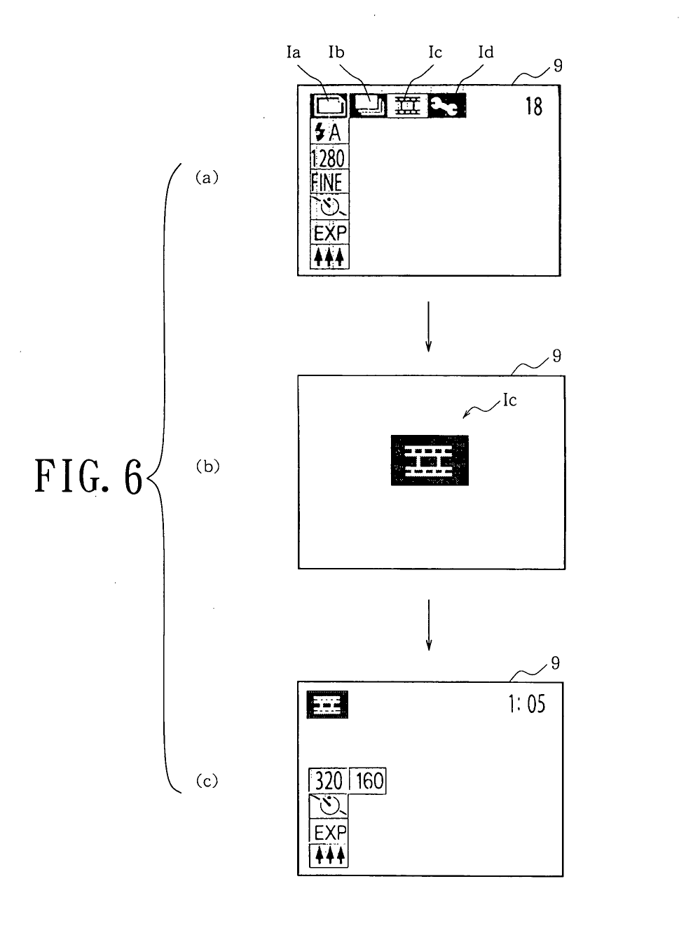

FIG. 6 is a diagram showing an example of screen display when a motion picture mode is to be set;

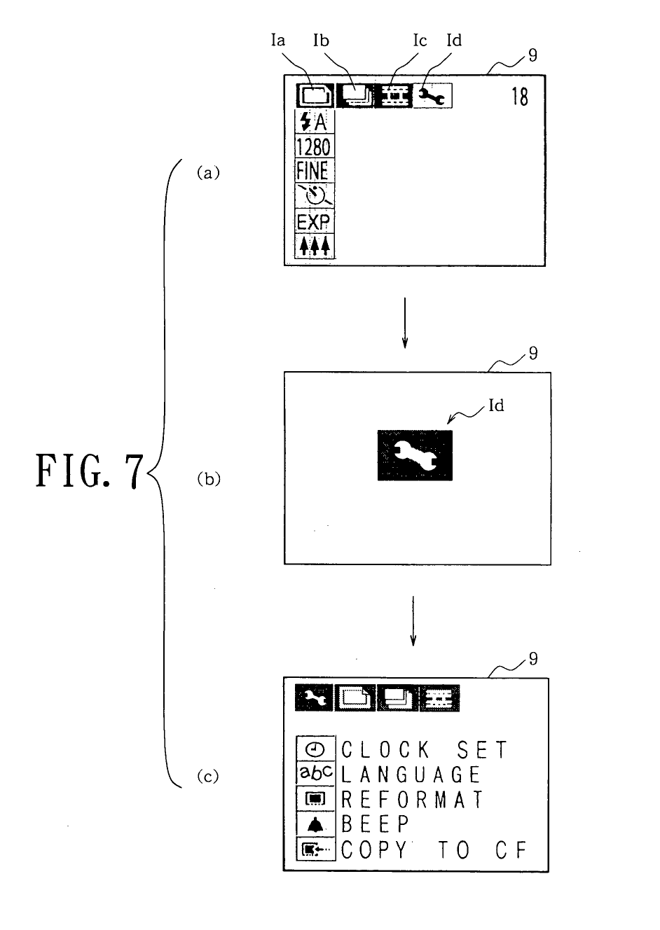

FIG. 7 is a diagram showing an example of screen display when an optional mode is to be set;

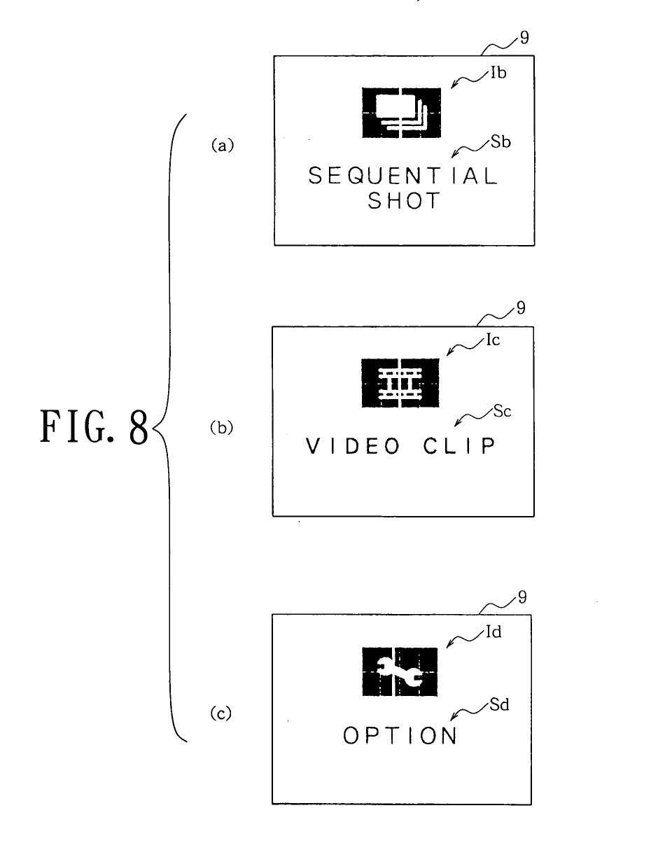

FIG. 8 is another example of screen display.

### BEST MODE FOR CARRYING OUT THE INVENTION

Embodiments of the invention will be described below in detail with reference to the drawings. With reference to FIG. 1, a digital camera of the present invention has a lens 3 for shooting and a view finder 10 which are arranged from a front face of a casing 1 to a forward direction. A shutter button 4 is arranged on an end of the casing 1. The lens 3 and view finder 10 are covered with an openable lens cover 2.

As shown in FIG. 2, the casing 1 has a rear surface including an image monitor 9, a main switch 5 to be manipulated for turning on/off power source and switching between shooting and playback, a mode button 7 to be manipulated for displaying a setting screen for changing over various set values including shooting resolution, etc., an arrow button 6 comprising four button pieces 6a, 6b, 6c, 6d and to be manipulated for selecting an icon from a plurality of icons shown on a menu screen, and a setting button 8 to be manipulated for setting a set value as to a selected icon.

PLAYBACK, CAMERA (SHOOTING), and MONITOR OFF can be changed over by a sliding manipulation of the main switch 5, as shown in FIG. 4(a).

The digital camera of the present invention makes it possible to set four modes including a still picture mode for shooting or reproducing a still picture, a motion picture mode for shooting or reproducing a motion picture, a continuous-shooting mode for shooting or reproducing a continuous-shooting picture, and an optional mode for setting date and time and the like. For selecting/setting the modes, a cursor on the screen is manipulated as will be described below. A conventional selection button for setting and changing over the mode is therefore omitted.

With the digital camera of the present invention, when the manipulation for setting a mode is performed, an icon indicating a mode to be set is displayed on a monitor screen over a constant period of time (one second) before the transition to the mode to be set.

FIG. 3 shows a procedure of switching the monitor screen display in response to a manipulation for setting a mode in shooting and playback. First in step S1 an inquiry is made as to whether a manipulation for mode setting is performed. If the answer is affirmative, a mode to be set is recognized and thereafter step S2 follows to start a timer T.

Next in step S3 an icon indicating the mode to be set is displayed on the monitor screen. Incidentally image data of an icon indicating each mode is pre-stored in a memory (not shown). In step S4 an inquiry is made as to whether a specified time TO (one second) elapses according to the timer T. If the answer is negative, the sequence returns to step S3 to continuously display the icon. If the answer for step S4 is affirmative, step S5 follows to delete the displayed icon and to display an initial screen of the set mode.

According to the described procedure, when the main switch 5 shown in FIG. 4(a) is changed over, for instance, to the position of SHOOTING (CAMERA) to open the lens cover 2, icon Ia of still picture mode, as shown in FIG. 4(b), will be displayed as magnified on a screen central portion of the image monitor 9 over one second. In this case the displayed icon Ia is an example indicating the mode which has previously been set (one of still picture mode, motion picture mode, continuous shooting mode, and optional mode). Thereafter a shooting screen of the still picture mode is presented on the image monitor 9 as shown in FIG. 4(c).

In this state the user manipulates the mode button 7 and further manipulates an upward-arrow button piece 6a of the arrow button 6, as shown in FIG. 5(a), to display in reduced scale, at a screen upper portion of the image monitor 9, four icons Ia, Ib, Ic, and Id indicating a still picture mode, motion picture mode, continuous shooting mode, and optional mode, respectively.

In this state the user manipulates, for example, a rightward arrow button piece 6c of the arrow button 6 to move the cursor to display the continuous shooting mode. Then the user manipulates the setting button 8 to display in magnified scale the icon Ib indicating the continuous shooing mode at a screen central portion of the image monitor 9 over one second as shown in FIG. 5(b). Thereafter an initial screen including a menu icon of the continuous shooting mode is displayed on the image monitor 9 as shown in FIG. 5(c).

Furthermore, in the state shown in FIG. 5(a) the user manipulates a rightward arrow button piece 6c of the arrow button 6 to move the cursor to display the motion picture mode as shown in FIG. 6(a). Then the user manipulates the setting button 8 to display in magnified scale the icon Ic indicating the motion picture mode at a screen central portion of the image monitor 9 over one second as shown in FIG. 6(b). Thereafter an initial screen including a menu icon of the motion picture mode is displayed on the image monitor 9 as shown in FIG. 6(c).

Still furthermore, in the state shown in FIG. 5(a) the user manipulates a rightward arrow button piece 6c of the arrow button 6 to move the cursor to the display of the optional mode, as shown in FIG. 7(a). Then the user manipulates the setting button 8 to display in magnified scale the icon Id indicating the optional mode at a screen central portion of the image monitor 9 over one second as shown in FIG. 7(b). Thereafter an initial screen including a menu icon of the optional mode is displayed on the image monitor 9 as shown in FIG. 7(c).

The digital camera embodying the present invention has another mode transition pattern: in the state shown in FIG. 4(c) the setting button 8 is manipulated to display the icon Ib indicating the continuous shooting mode in magnified scale on the image monitor 9 over one second as shown in FIG. 5(b), thereafter to display a shooting screen of the continuous shooting mode. In this state the setting button 8 is further manipulated to display the icon Ic indicating the motion picture mode in magnified scale on the image monitor 9 over one second as shown in FIG. 6(b), thereafter to display a shooting screen of the motion picture mode. Furthermore in this state the setting button 8 is manipulated to return to the display of the icon Ia of the still picture mode as shown in FIG. 4(b).

As the same case of the above, when the main switch 5 shown in FIG. 4(a) of the digital camera embodying the present invention is changed over to PLAYBACK, setting one of still picture mode, motion picture mode, continuous shooting mode, and optional mode displays an icon indicating the set mode at the central portion of the image monitor 9.

As described above, the digital camera of the present invention enables the user to visually confirm which mode has been set with an icon displayed right after the manipulation for selecting/setting a mode, whereby the user can feel at ease in the manipulation.

The device of the present invention is not limited to the foregoing embodiment in construction but can be modified variously within the technical scope as set forth in the appended claims. For example, only an icon need not be displayed in setting a mode but, as shown in FIGS. 8(a), (b), (c), character strings Sb, Sc, Sd indicating call names of the modes can also be displayed along with the icons Ib, Ic, Id, or only character strings Sb, Sc, Sd can be displayed.

1. A digital camera which is adapted to set one mode from among a plurality of modes including a still picture mode for shooting or reproducing a still picture in response to a manipulation for setting a mode, the digital camera being characterized in that an image indicating a mode to be set is displayed on a monitor over a constant period of time when the manipulation for setting the mode is performed.

2. A digital camera according to claim 1 which comprises image storage for storing images indicating the plurality of modes, respectively, recognizer for recognizing the mode to be set in response to the manipulation for setting the mode, measurer for measuring the constant period of time in response to the manipulation for setting the mode, and displayer for displaying on a monitor the image stored in said image storage over the constant period of time.

3. A digital camera according to claim 1 wherein setting the mode is performed by manipulating a cursor on a screen such that one mode is selected and set from a plurality of modes shown on a monitor screen.

4. A digital camera according to claim 1 wherein the image indicating the mode is an icon indicating characteristics of the mode.

5. A digital camera according to claim 1 wherein the image indicating the mode is character strings indicating a call name of the mode.

6. A digital camera according to claim 2 wherein setting the mode is performed by manipulating a cursor on a screen such that one mode is selected and set from a plurality of modes shown on a monitor screen.

7. A digital camera according to claim 2 wherein the image indicating the mode is an icon indicating characteristics of the mode.

8. A digital camera according to claim 3 wherein the image indicating the mode is an icon indicating characteristics of the mode.

9. A digital camera according to claim 2 wherein the image indicating the mode is character strings indicating a call name of the mode.

10. A digital camera according to claim 3 wherein the image indicating the mode is character strings indicating a call name of the mode.
